(19) United States
(12) Patent Application Publication
(10) Pub. No.: US 2026/0226781 A1
(43) Pub. Date: Aug. 6, 2026

(54) HYDRAULIC LIFT SYSTEM OF A TRAILER DOOR AND METHOD OF ASSEMBLY

(71) Applicant: Freedom Trailers, LLC, Willacoochee, GA (US)

(72) Inventor: Harold L. Baxley, Tifton, GA (US)

(21) Appl. No.: 19/042,205

(22) Filed: Jan. 31, 2025

(51) Int. Cl. E05F 15/53; F15B 15/14; F15B 15/18

(52) U.S. Cl. CPC E05F 15/53; E05Y 2900/516

(57) ABSTRACT

A hydraulic lift system of a trailer door may include a trailer frame; a trailer door connected to the frame; a hydraulic cylinder including a piston rod; a hydraulic cylinder mount connected to a frame member of the trailer frame, the hydraulic cylinder mount connected to a second end; a hydraulic pump transferring fluid to the hydraulic cylinder to move the piston rod outward at a first end of the hydraulic cylinder in an extended state, and transferring fluid from the hydraulic cylinder to move the piston rod inward at the first end of the hydraulic cylinder in a retracted state; a linkage assembly including a first portion connected to the piston rod of the hydraulic cylinder and a second portion connected to the trailer door.

### CROSS-REFERENCE TO RELATED APPLICATION(S)

This application claims priority to and benefits of U.S. Provisional Application No. 63/627,570, filed on Jan. 31, 2024, the entire contents of which is herein incorporated by reference.

### BACKGROUND

### 1. Technical Field

Embodiments relate to a hydraulic lift system of a trailer door and a method of assembly of such a hydraulic lift system.

### 2. Discussion of Related Art

Trailers such as enclosed trailers are available for a wide variety of uses today. As but just a few limited examples, trailers may be constructed to serve as mobile concession stands, mobile food businesses (e.g., a mobile barbeque catering platform), mobile stages, car haulers, utility trailers, and tiny homes.

Many trailers include a trailer door as a rear door and/or side door (or stage) for the trailer. Such trailer doors are constructed to serve multiple purposes. As a first example purpose, a rear door may serve as a wall or closed door when shut, and as a ramp when lowered such that users and equipment may be moved up the door that serves as a ramp into the trailer. For instance, a car hauler may include a ramp door that when lowered serves as a ramp upon which a car may be driven onto from ground level up and into the trailer. In another embodiment, a concession trailer may include a trailer door that when lowered serves as a ramp upon which people may enter, and upon which heavy concession equipment may be loaded into the trailer.

As another example purpose of trailer doors, a side door may serve as a wall or closed door when shut, and as a stage when lowered such that users may stand on the door that serves as a stage when lowered to an appropriate position. For instance, a mobile stage truck trailer may include a side door that may serve as a concert stage when lowered to be generally horizontal with ground level (e.g., inches to feet above ground).

To provide desirable functionality, such trailer doors serving multiple functions may be constructed to support relatively heavy weight (e.g., the weight of people and equipment). As such, trailer doors themselves may be relatively heavy and may require considerable effort to raise when lowered so as to shut the trailer door. Similarly, such trailer doors may require considerable effort to lower when shut so as to open the trailer door. In both cases (raising and lowering), such trailer doors pose safety hazards that can result in serious injury and even death. Additionally, related art lift assemblies and stage support systems may further complicate manufacturing and operation, and may increase manufacturing costs.

This Background section may contain recognitions of one or more problems in the related art that were derived in conjunction with the embodiments presented herein. Accordingly, none of the related art discussed in this Background section should be considered as “admitted-art” in the public domain prior to the effective filing date of this application.

### SUMMARY

Embodiments provide hydraulic lift systems for trailer doors and methods of assembling the same. These systems are designed to improve the efficiency, safety, and ease of operating trailer doors.

According to an embodiment, a hydraulic lift system of a trailer door may include a trailer frame; the trailer door rotatably connected to the frame; a hydraulic cylinder including a piston rod extending outward at a first end of the hydraulic cylinder; a hydraulic cylinder mount connected to a frame member of the trailer frame, the hydraulic cylinder mount connected to a second end of the hydraulic cylinder; a hydraulic pump transferring fluid to the hydraulic cylinder to move the piston rod outward at the first end of the hydraulic cylinder in an extended state, and transferring fluid from the hydraulic cylinder to move the piston rod inward at the first end of the hydraulic cylinder in a retracted state; a linkage assembly including a first portion connected to the piston rod of the hydraulic cylinder and a second portion connected to the trailer door. An open state of the trailer door may correspond to the retracted state of the piston rod of the hydraulic cylinder, and a closed state of the trailer door may correspond to an extended state of the piston rod of the hydraulic cylinder.

In an embodiment, the first portion of the linkage assembly may be a solid metal “L”-shaped member.

In an embodiment, the second portion of the linkage assembly may be a solid metal plate.

In an embodiment, the first portion of the linkage assembly and the second portion of the linkage assembly may be physically connected to each other.

In an embodiment, the first portion of the linkage assembly and the second portion of the linkage assembly may be welded to each other.

In an embodiment, the hydraulic cylinder, the hydraulic cylinder mount, and the linkage assembly may each be one among a plurality of hydraulic cylinders, hydraulic cylinder mounts, and linkage assemblies.

In an embodiment, the hydraulic pump may be provided with a plurality of hydraulic lines to fluidly control the plurality of hydraulic cylinders.

In an embodiment, the hydraulic pump may be provided as one among a plurality of hydraulic pumps, each of which is connected in a one-to-one relationship with a corresponding one of the plurality of hydraulic cylinders.

In an embodiment, at least one of the first end of the hydraulic cylinder and the second end of the hydraulic cylinder may include a clevis mount.

In an embodiment, the hydraulic cylinder may be a double-acting hydraulic cylinder.

According to another embodiment, a hydraulic lift system of a trailer door may include a hydraulic cylinder including a piston rod extending outward at a first end of the hydraulic cylinder; a hydraulic cylinder mount configured to be connected to a trailer, the hydraulic cylinder mount connected to a second end of the hydraulic cylinder; a hydraulic pump transferring fluid to the hydraulic cylinder to move the piston rod outward at the first end of the hydraulic cylinder in an extended state, and transferring fluid from the hydraulic cylinder to move the piston rod inward at the first end of the hydraulic cylinder in a retracted state; a linkage assembly including a first portion connected to the piston rod of the hydraulic cylinder and a second portion configured to be connected to a trailer door of the trailer. An open state of the trailer door may correspond to the retracted state of the piston rod of the hydraulic cylinder, and a closed state of the trailer door may correspond to an extended state of the piston rod of the hydraulic cylinder.

In an embodiment, the first portion of the linkage assembly may be a solid metal “L”-shaped member.

In an embodiment, the second portion of the linkage assembly may be a solid metal plate.

In an embodiment, the first portion of the linkage assembly and the second portion of the linkage assembly may be physically connected to each other.

In an embodiment, the first portion of the linkage assembly and the second portion of the linkage assembly may be welded to each other.

According to an embodiment, a method of assembling a hydraulic lift system of a trailer door may include providing the trailer door rotatably connected to a trailer frame; connecting a hydraulic cylinder including a piston rod extending outward at a first end of the hydraulic cylinder to a hydraulic cylinder mount connected to a frame member of the trailer frame at a second end of the hydraulic cylinder; attaching a hydraulic pump to the trailer frame, the hydraulic pump transferring fluid to the hydraulic cylinder to move the piston rod outward at the first end of the hydraulic cylinder in an extended state, and transferring fluid from the hydraulic cylinder to move the piston rod inward at the first end of the hydraulic cylinder in a retracted state; and connecting a linkage assembly including a first portion connected to the piston rod of the hydraulic cylinder and a second portion connected to the trailer door. An open state of the trailer door may correspond to the retracted state of the piston rod of the hydraulic cylinder, and a closed state of the trailer door may correspond to an extended state of the piston rod of the hydraulic cylinder.

In an embodiment, the first portion of the linkage assembly may be a solid metal “L”-shaped member.

In an embodiment, the second portion of the linkage assembly may be a solid metal plate.

In an embodiment, the first portion of the linkage assembly and the second portion of the linkage assembly may be physically connected to each other.

In an embodiment, the first portion of the linkage assembly and the second portion of the linkage assembly may be welded to each other.

The foregoing Summary section is merely intended to provide an overview of the subject matter disclosed herein. Many other features, aspects, and embodiments will be apparent to those of ordinary skill in the art in view of the description and accompanying figures. All such embodiments should be considered within the scope of this disclosure.

### BRIEF DESCRIPTION OF THE DRAWINGS

The above and other aspects, features, and embodiments of the disclosure will become more apparent by describing in detail embodiments thereof with reference to the attached drawings, in which:

FIG. 1 is a schematic perspective view of a hydraulic lift system of a trailer door according to an embodiment.

FIG. 2 is another schematic perspective view of the hydraulic lift system of a trailer door of FIG. 1.

FIG. 3 includes multiple schematic views of a hydraulic cylinder according to an embodiment.

FIG. 4 is a schematic perspective view of a hydraulic lift system of a trailer door according to another embodiment.

FIG. 5 is a schematic perspective view of a linkage assembly of the hydraulic lift system of FIG. 4.

FIG. 6 is a schematic perspective view of a hydraulic cylinder mount of the hydraulic lift system of FIG. 4.

FIG. 7 is a schematic flowchart of a method of assembling a hydraulic lift system of a trailer door according to an embodiment.

### DETAILED DESCRIPTION OF THE EMBODIMENTS

Embodiments will now be described with reference to the accompanying drawings. The disclosure may be embodied in many different forms and should not be construed as limited to the embodiments set forth herein. Like reference numerals refer to like elements throughout.

In the drawings, elements and their measurements may be exaggerated for ease of description and for clarity.

Use of singular forms (e.g., “a”, “an”, “the”) should be interpreted to include plural forms as well, unless the context clearly indicates otherwise.

In the specification and the claims, the term “and/or” is intended to include any combination of the terms “and” and “or” for the purpose of its meaning and interpretation. The terms “and” and “or” may be used in the conjunctive or disjunctive sense and may be understood to be equivalent to “and/or.”

The term “at least one of” when used in conjunction with “and” should be interpreted to mean one or more instances of the listed items, and not as always requiring one instance of each of the listed items. For example, “at least one of A and B” includes A, B, AA, BB, or AB, but does not require the presence of both A and B.

The terms “comprises,” “comprising,” “includes,” and/or “including,”, “has,” “have,” and/or “having,” and variations thereof when used herein, specify the presence of stated elements, but do not preclude the presence or addition of one or more other elements.

When an element is described as being “connected to” another element the element may be directly connected to the other element, or one or more intervening elements may be present between the element and the other element, unless the context clearly indicates otherwise. The term “connected” may mean, e.g., that one element is “attached” to another element, and also may include a case where one element is integral to the other element.

Terms such as “about,”, “approximately”, “generally,” “substantially,” and the like are to be construed as modifying a term or value such that it is not an absolute. Such terms will be defined by the circumstances and the terms that they modify as those terms are understood by those of skill in the art. This includes, at very least, the degree of expected experimental error, technique error and instrument error for a given technique used to measure a value.

As discussed above, a trailer door may be relatively heavy and may require considerable effort to raise when lowered so as to shut the trailer door, or to lower when shut so as to open the trailer door. As an example range, a trailer ramp door for a 6′ tall (when in an upright position) by 6′ wide trailer may way approximately 150 lbs while a trailer ramp door for a 6′6″ tall by 8′6″ wide trailer may weigh up to approximately 300 lbs. A trailer side door having larger dimensions may weigh even more. Accordingly, one or more lift assist devices may be desirable for a trailer door so that a single user may raise and/or lower the ramp door without strain and/or injury.

Supply chain issues and manufacturing complexity and cost may be magnified when manufacturing trailers with related art lift assist devices. Further, such related art lift assist devices may be relatively inferior compared to embodiments presented herein, both in terms of function and also in terms of operator experience.

Accordingly, a hydraulic lift system of a trailer door and a method of assembly of such a hydraulic lift system of a trailer door are hereby presented. Embodiments provide an improved lift assist device that may enable even a single user to raise and/or lower a trailer door without strain and/or injury. Embodiments may be superior in terms of performance with respect to related art lift assist devices such as hinge mount ramp assist springs and torsion springs. In addition, embodiments according to the present disclosure may streamline (e.g., simplify) lift assist device procurement processes, simplify manufacturing processes, and lower manufacturing costs.

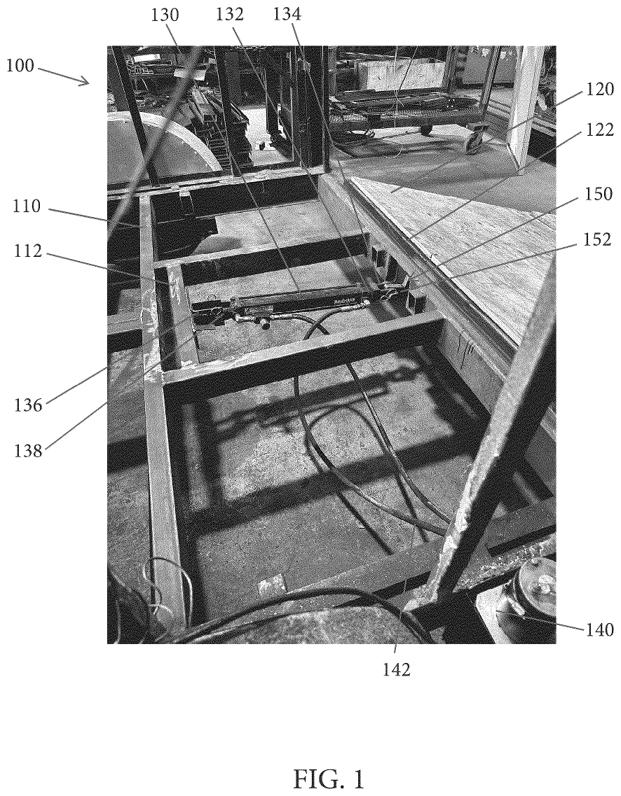

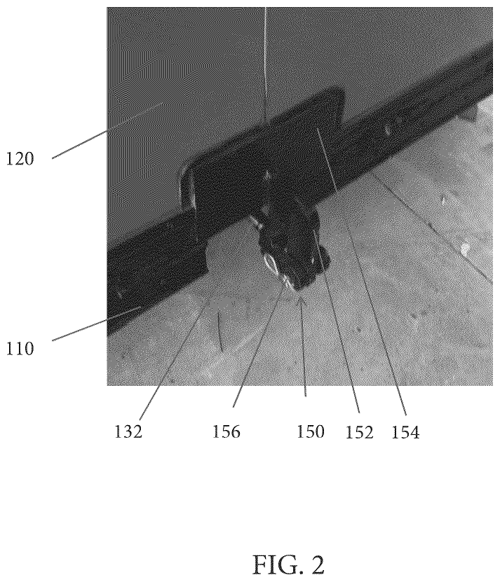

FIG. 1 is a schematic perspective view of a hydraulic lift system of a trailer door 100 according to an embodiment. FIG. 2 is another schematic perspective view of the hydraulic lift system of a trailer door 100 of FIG. 1. In FIG. 1, the hydraulic lift system 100 is shown from a vantage point of a first side of a trailer door 120 opening of the hydraulic lift system 100 (e.g., inside), and in FIG. 2 the hydraulic lift system 100 is shown from a vantage point of a second side of the trailer door 120 opening (e.g., outside). In FIG. 1, the trailer door 120 is open (in an open state), and in FIG. 2 the trailer door 120 is closed (in a closed state).

The hydraulic lift system 100 may include a trailer frame 110, a trailer door 120, a hydraulic cylinder 130, a hydraulic pump 140, and a linkage assembly 150. The hydraulic lift system 100 depicted in FIGS. 1 and 2 may include a trailer ramp door. However, embodiments of the disclosure are not limited thereto.

The trailer frame 110 may serve as the main supporting structure of a trailer and may include the chassis and box frame portions of the trailer. The trailer frame may include portions that are welded together as well as portions that are connected, e.g., by bolt. As discussed more herein, the trailer frame 110 may include a frame member 112 configured for connection to a hydraulic cylinder mount 136. The trailer frame 110 may be constructed of one or more materials. For example, the trailer frame 110 may be formed of steel, other metals, composites, or the like. The trailer frame 110 may be sized such that the trailer door 120 corresponds to the dimensions of the trailer frame 110.

The trailer door 120 may be rotatably connected to the trailer frame 110. For example, one or more hinges 122 may be connected to the trailer frame 110 and the trailer door 120. The one or more hinges may provide an axis around or about which the trailer door may rotate.

The trailer door 120 may function as a ramp for ingress and egress to a trailer when lowered, and may function as a closed door (or wall) for the trailer when raised. The trailer door 120 may be constructed of one or more materials. For example, the trailer ramp door 102 may be formed of steel, other metals, sheet metal, oriented strand board, vinyl paneling, composites, wood, or the like. In an embodiment, a door frame portion of the trailer door 120 may be formed of a metal (e.g., steel) while remaining portions of the trailer door 120 may be formed of wood and/or composite materials.

A typical trailer door size may be 6′ tall by 6′ wide, which may weigh in a range of approximately 150 lbs. to 200 lbs. Another typical trailer door size may be 6′3″ tall by 7′ wide, which may weigh in a range of approximately 175 lbs. to 225 lbs. Yet another typical trailer door size may be 6′6″ high by 8′6″ wide, which may weigh in a range of approximately 200 lbs. to 300 lbs. These are merely example specifications to aid in understanding and, like other aspects of this disclosure, embodiments are not limited thereto.

The hydraulic cylinder 130 may include a piston rod 132 extending outward at a first end 134 of the hydraulic cylinder 130. The trailer door system 100 may further include the hydraulic cylinder mount 136 connected to the frame member 112 of the trailer frame 110.

The hydraulic cylinder mount 136 may be connected to a second end 138 of the hydraulic cylinder 130 (e.g., by pin). In an embodiment, the hydraulic cylinder mount 136 may be formed of a first plate that is flat and connected to (e.g., welded or bolted) to the frame member 112. In another embodiment, the first plate may be composed of a side of the frame member 112. A second plate may be connected (e.g., welded or bolted) or integral to the first plate. The second plate may be curved in a “U”-shape and configured to connect to the second end 138 of the hydraulic cylinder (e.g., by a pin). In another embodiment, the second plate may be a single plate protruding outward from (e.g., perpendicular to) the first plate and may be configured to connect to the second end 138 of the hydraulic cylinder (e.g., by a pin). In an embodiment, the first and second plates may be formed of steel, other metals, composite materials, or the like. In another embodiment, the hydraulic cylinder mount 136 may include additional structural supports such as additional metal plates attached to the first and second plates. In other embodiments, the hydraulic cylinder mount 136 may include a frame assembly.

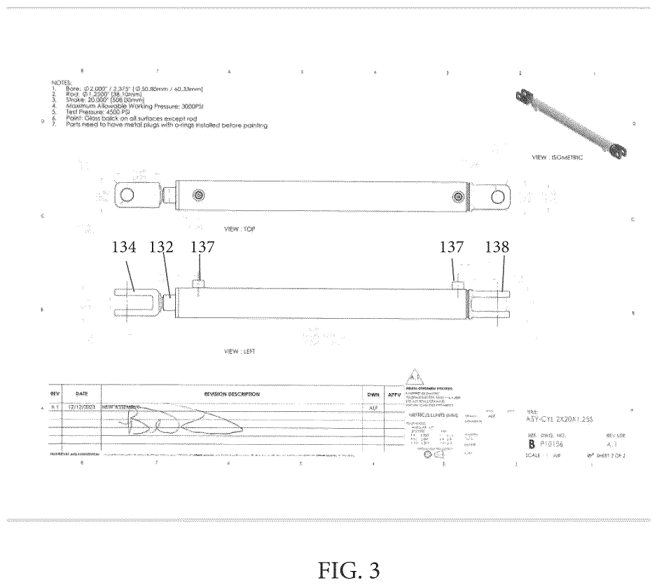

FIG. 3 includes multiple schematic views of a hydraulic cylinder 130 according to an embodiment. In two of the views of FIG. 3, the hydraulic cylinder 130 is rotated approximately 180 degrees from the view shown in FIG. 1. Accordingly, the piston rod 132 and first end 134 of the hydraulic cylinder is shown on the left in FIG. 3, and the second end 138 of the hydraulic cylinder is shown on the right in FIG. 3. In an embodiment, the hydraulic cylinder 130 may include a clevis mount (e.g., shackle) at one or both of the first and second ends 134, 138 of the hydraulic cylinder. Said clevis mounts may be configured to receive pins for mounting. In more detail, the clevis mount of the first end 134 may be connected to the outward end of the piston rod 132. A clevis mount of the second end 138 may be connected to the hydraulic cylinder mount 136.

In an embodiment, the hydraulic cylinder 130 may be a double-acting hydraulic cylinder including two ports 137 for connection to the hydraulic pump 140. One of the ports 137 may be for pushing hydraulic fluid into the hydraulic cylinder 130 thereby causing the piston rod 132 to extend outward. The other of the ports 137 may be for pulling hydraulic fluid from the hydraulic cylinder 130 thereby causing the piston rod 132 to retract inward. In another embodiment, the hydraulic cylinder 130 may be a single-acting hydraulic cylinder including a single port. The hydraulic cylinder 130 may be constructed of one or more materials. For example, the hydraulic cylinder 130 may be formed of steel and/or aluminum, other metals, composites (e.g., carbon fiber), or the like.

In an embodiment of FIG. 3, the hydraulic cylinder 130 may include a bore diameter of 2 inches/2.375 inches (50.80 mm/60.33 mm). The piston rod 132 may include a diameter of 1.25 inches (38.10 mm) and a stroke of 20 inches (508 mm). The maximum allowable working pressure of the hydraulic cylinder 130 may be 3000 pounds per square inch (PSI). These are merely example specifications to aid in understanding and, like other aspects of this disclosure, embodiments are not limited thereto.

The hydraulic pump 140 may be in fluid communication with the hydraulic cylinder 130 such as by one or more hydraulic lines 142 connected to ports 137. The hydraulic pump 140 may transfer fluid (e.g., a predetermined flow of fluid) to the hydraulic cylinder 130 to move the piston rod 132 outward at the first end 134 of the hydraulic cylinder 130 in an extended state (shown in FIG. 2). The hydraulic pump 140 may transfer fluid (e.g., a predetermined flow of fluid) from the hydraulic cylinder 130 to move the piston rod 132 inward at the first end 134 of the hydraulic cylinder 130 in a retracted state (shown in FIG. 1). In the trailer door system 100 according to an embodiment, the open state of the trailer door 120 may correspond to the retracted state of the piston rod 132 of the hydraulic cylinder 130, and the closed state of the trailer door 120 may correspond to the extended state of the piston rod 132 of the hydraulic cylinder 130.

The hydraulic pump 140 may include a reservoir for containing hydraulic fluid. The hydraulic pump 140 may include ports or other connections corresponding to ports 137 of the hydraulic cylinder 130 and may be connected thereto by hydraulic lines 142. The hydraulic pump 140 may include a motor and may be in a double acting configuration or a single acting configuration so as to correspond to the configuration of the hydraulic cylinder 130.

In an embodiment, the hydraulic pump may be a double acting configuration design, and may include a capacity in a range of 0.5 gallons per minute (GPM) to 100 GPM. For example, the hydraulic pump may include a capacity of 1 GPM to 5 GPM per minute. The hydraulic pump may include a maximum pressure in a range of 50 PSI to 15,000 PSI. For example, the hydraulic pump may include a maximum pressure in a range of 200 PSI to 5000 PSI. These are merely example specifications to aid in understanding and, like other aspects of this disclosure, embodiments are not limited thereto.

The linkage assembly 150 may include a first portion 152 connected to the piston rod 132 of the hydraulic cylinder 130 and a second portion 154 connected to the trailer door 120.

In an embodiment, the linkage assembly 150 may include a solid plate as the first portion 152. In other embodiments, the first portion 152 may include a frame assembly. In a plate embodiment, the plate may be formed of steel, other metals, composite materials, or the like. For example, the solid plate may be connected (e.g., welded or integral to) the second portion 154. In an embodiment, the plate may be formed of ⅜ inch thick steel and may be “L”-shaped. The plate may be dimensions so as to be configured to connect to the second portion 154 at one end of the L and to the clevis mount of the piston rod 132 at the other end of the L. For example, the clevis mount may be a ¾ inch clevis mount. These are merely example specifications to aid in understanding and, like other aspects of this disclosure, embodiments are not limited thereto.

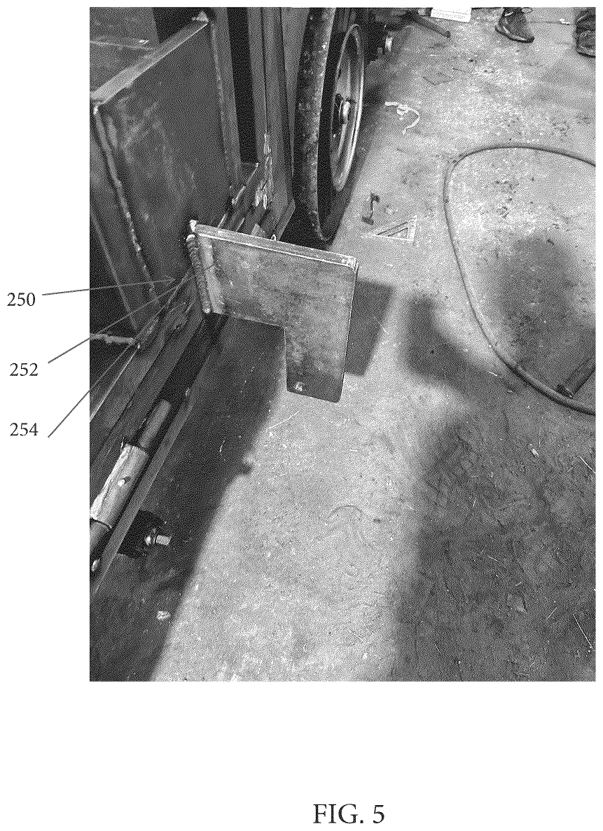

In an embodiment the second portion 154 may be welded to a frame of the trailer door 120 (see, e.g., FIG. 5). In other embodiments, the second portion 154 may be otherwise connected (e.g., bolted) to a frame of the trailer door 120. In other embodiments, the second portion 154 may be connected to other portions of the trailer door in addition to or alternatively to the frame of the trailer door 120. In yet other embodiments, the second portion 154 may be composed of a frame member of the trailer door 120.

In an embodiment, the second portion 154 may include a plate. In other embodiments, the second portion 154 may include a frame assembly. In a plate embodiment, the plate may be formed of steel, other metals, composite materials, or the like. In an embodiment, the plate may be formed of solid steel and may be square or rectangular in shape. The plate may be dimensions so as to be configured to connect to the frame of the trailer door 120 (e.g., by welding) at one or more desirable positions. For example, the plate may be in a range of 5 inches wide to 60 inches wide and 5 inches tall to 60 inches tall. In an embodiment, the plate may be in a range of 6 inches wide to 48 inches wide and 6 inches tall to 48 inches tall. In an embodiment, the plate may be in a range of 8 inches wide to 24 inches wide and 8 inches tall to 12 inches tall. These are merely example specifications to aid in understanding and, like other aspects of this disclosure, embodiments are not limited thereto.

In an embodiment, the linkage assembly 150 may be rotatably connected to the piston rod 132 of the hydraulic cylinder 130 by a pin 156 through a hole of the first portion 152 and holes of the clevis mount of the piston rod 132. The pin 156 may provide an axis around or about which the linkage assembly 150 may rotate. The linkage assembly 150 including the pin 156 may function with the clovis end of the piston rod 132 to transfer force of the piston rod 132 to the trailer door 120. For example, the linear force of the piston rod 132 may be transferred to rotational force by the linkage assembly 150 and applied to the trailer door 120. The pin 156 may be formed of steel or other metals, or composite materials. These are merely example specifications to aid in understanding and, like other aspects of this disclosure, embodiments are not limited thereto.

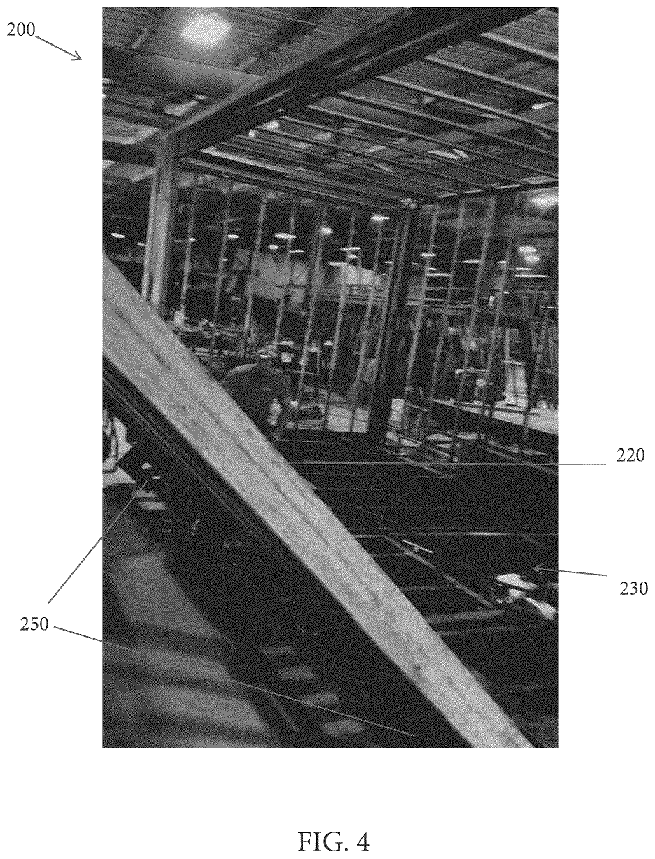

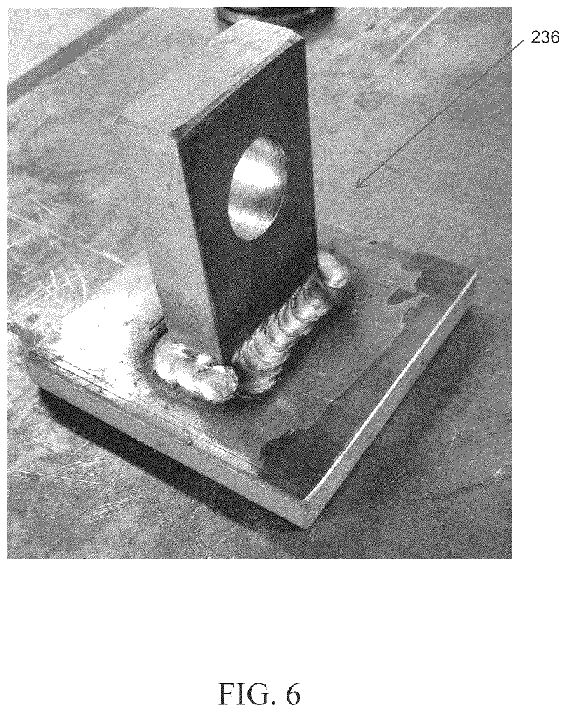

FIG. 4 is a schematic perspective view of a hydraulic lift system of a trailer door 200 according to another embodiment. FIG. 5 is a schematic perspective view of a linkage assembly 250 of the hydraulic lift system of FIG. 4. FIG. 6 is a schematic perspective view of a hydraulic cylinder mount 236 of the hydraulic lift system of FIG. 4. Those aspects of the hydraulic lift system of a trailer door 200 already described with respect to the hydraulic lift system of a trailer door 100 of FIG. 1 will be omitted or only briefly mentioned in the interest of brevity. The same or similar descriptions of such aspects are applicable with respect to the hydraulic lift system of a trailer door 200. In FIG. 4, the trailer door system 200 is shown in a partially open (i.e., partially closed) state.

The trailer door system 200 may include a trailer frame 210, a trailer door/wall 220, two or more hydraulic cylinders 230, two or more hydraulic cylinder mounts 236, one or more hydraulic pumps 240, and two or more linkage assemblies 250. The trailer door system 200 depicted in FIGS. 4 and 5 may include a trailer stage door. However, embodiments of the disclosure are not limited thereto.

The trailer door 220 may be rotatably connected to the trailer frame 210 using one or more hinges connected to the trailer frame 210 and trailer door. The one or more hinges may provide an axis around or about which the trailer door may rotate. The trailer door 220 may function as a stage upon which people and/or equipment may be placed when lowered to a horizontal position, and may function as a closed door (or wall) for the trailer when raised. The trailer door 220 may be constructed similarly to the trailer door of FIG. 1, but may be configured for attachment to the trailer frame 210 by one or more hinges, and by multiple hydraulic cylinder mounts 236, hydraulic cylinders 230, and linkage assemblies 250.

For example, turning to FIG. 5, a single linkage assembly 250 including a first portion 252 and a second portion 254 are shown, but this same configuration may be provided in plural (e.g., 2). Similarly, in FIG. 6, a single hydraulic cylinder mount 236 is shown, but this same configuration may be provided in plural (e.g., 2).

In an embodiment, two or more hydraulic cylinders 230 may be provided, each for attachment to a hydraulic cylinder mount 236 at one end and a linkage 250 at the other. One or more hydraulic pumps 240 may be provided to power the two or more hydraulic cylinders. In an embodiment, one hydraulic pump may be provided with appropriate lines to power (fluidly control) the two or more hydraulic cylinders 230. In another embodiment, two or more hydraulic pumps may be provided in a one-to-one relationship with respect to the two or more hydraulic cylinders 230.

In the trailer door system 200 according to an embodiment, the open state of the trailer door 220 (stage state) may correspond to the retracted state of the piston rods 232 of the two or more hydraulic cylinders 230, and the closed state of the trailer door 220 (wall state) may correspond to the extended state of the piston rods 232 of the two or more hydraulic cylinders.

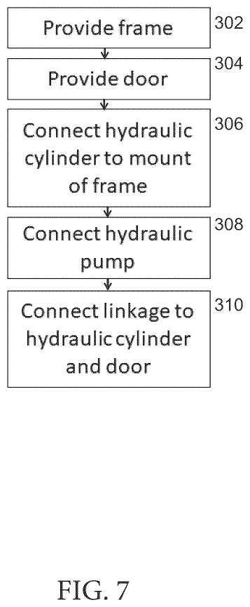

FIG. 7 is a schematic flowchart of a method 300 of assembling a hydraulic lift system of a trailer door according to an embodiment. For ease of description, the method 300 is described with respect to an embodiment of a hydraulic lift system of a trailer door 100 described in conjunction with FIG. 1.

In operation 302 a trailer frame 110 may be provided. In operation 304, a trailer door 120 rotatably connected to the frame 110 may be provided.

In operation 306, a hydraulic cylinder 130 including a piston rod 132 extending outward at a first end 134 of the hydraulic cylinder may be connected to a hydraulic cylinder mount 136 connected to a frame member 112 of the trailer frame 110 at a second end 138 of the hydraulic cylinder.

In operation 308, a hydraulic pump 140 may be connected to the trailer frame 110, the hydraulic pump 140 transferring fluid (e.g., a predetermined flow of fluid) to the hydraulic cylinder 130 to move the piston rod 132 outward at the first end 134 of the hydraulic cylinder in an extended state, and transferring fluid (e.g., a predetermined flow of fluid) from the hydraulic cylinder 130 to move the piston rod 132 inward at the first end 134 of the hydraulic cylinder in a retracted state.

In operation 310, a linkage assembly 150 including a first portion 152 connected to the piston rod 132 of the hydraulic cylinder and a second portion 154 connected to the trailer door 120. An open state of the trailer door may correspond to the retracted state of the piston rod of the hydraulic cylinder, and a closed state of the trailer door may correspond to an extended state of the piston rod of the hydraulic cylinder.

Embodiments of the hydraulic lift system of a trailer door and method of assembly of such a hydraulic lift system of a trailer door may provide a number of benefits including improved lowering assistance and lift assistance for a user, and reduced safety risk. Embodiments may provide for more simplified manufacturing processes and lower manufacturing costs. Further, operation of such a hydraulic lift system of a trailer door may be more readily accomplished in comparison to related art lift assemblies and stage support systems thereby leading to superior operator experience.

Embodiments have been disclosed herein, and although terms are employed, they are used and are to be interpreted in a generic and descriptive sense only and not for purpose of limitation. In some instances, as would be apparent by one of ordinary skill in the art, elements described in connection with an embodiment may be used singly or in combination with elements described in connection with other embodiments. Accordingly, it will be understood by those of ordinary skill in the art that various changes in form and details may be made without departing from the spirit and scope of the disclosure.

What is claimed is:

1. A hydraulic lift system of a trailer door, comprising:
a trailer frame;
the trailer door rotatably connected to the trailer frame;
a hydraulic cylinder including a piston rod extending outward at a first end of the hydraulic cylinder;
a hydraulic cylinder mount connected to a frame member of the trailer frame, the hydraulic cylinder mount connected to a second end of the hydraulic cylinder;
a hydraulic pump transferring fluid to the hydraulic cylinder to move the piston rod outward at the first end of the hydraulic cylinder in an extended state, and transferring fluid from the hydraulic cylinder to move the piston rod inward at the first end of the hydraulic cylinder in a retracted state; and
a linkage assembly including a first portion connected to the piston rod of the hydraulic cylinder and a second portion connected to the trailer door,
wherein an open state of the trailer door corresponds to the retracted state of the piston rod of the hydraulic cylinder, and
wherein a closed state of the trailer door corresponds to an extended state of the piston rod of the hydraulic cylinder.

2. The hydraulic lift system of claim 1, wherein the first portion of the linkage assembly is a solid metal “L”-shaped member.

3. The hydraulic lift system of claim 1, wherein the second portion of the linkage assembly is a solid metal plate.

4. The hydraulic lift system of claim 3, wherein the first portion of the linkage assembly and the second portion of the linkage assembly are physically connected to each other.

5. The hydraulic lift system of claim 4, wherein the first portion of the linkage assembly and the second portion of the linkage assembly are welded to each other.

6. The hydraulic lift system of claim 1, wherein the hydraulic cylinder, the hydraulic cylinder mount, and the linkage assembly are each one among a plurality of hydraulic cylinders, hydraulic cylinder mounts, and linkage assemblies.

7. The hydraulic lift system of claim 6, wherein the hydraulic pump is provided with a plurality of hydraulic lines to fluidly control the plurality of hydraulic cylinders.

8. The hydraulic lift system of claim 6, wherein the hydraulic pump is provided as one among a plurality of hydraulic pumps, each of which is connected in a one-to-one relationship with a corresponding one of the plurality of hydraulic cylinders.

9. The hydraulic lift system of claim 1, wherein at least one of the first end of the hydraulic cylinder and the second end of the hydraulic cylinder includes a clevis mount.

10. The hydraulic lift system of claim 1, wherein the hydraulic cylinder is a double-acting hydraulic cylinder.

11. A hydraulic lift system of a trailer door, comprising:
a hydraulic cylinder including a piston rod extending outward at a first end of the hydraulic cylinder;
a hydraulic cylinder mount configured to be connected to a trailer, the hydraulic cylinder mount connected to a second end of the hydraulic cylinder;
a hydraulic pump transferring fluid to the hydraulic cylinder to move the piston rod outward at the first end of the hydraulic cylinder in an extended state, and transferring fluid from the hydraulic cylinder to move the piston rod inward at the first end of the hydraulic cylinder in a retracted state;
a linkage assembly including a first portion connected to the piston rod of the hydraulic cylinder and a second portion configured to be connected to a trailer door of the trailer,
wherein an open state of the trailer door corresponds to the retracted state of the piston rod of the hydraulic cylinder, and
wherein a closed state of the trailer door corresponds to an extended state of the piston rod of the hydraulic cylinder.

12. The hydraulic lift system of claim 11, wherein the first portion of the linkage assembly is a solid metal “L”-shaped member.

13. The hydraulic lift system of claim 11, wherein the second portion of the linkage assembly is a solid metal plate.

14. The hydraulic lift system of claim 13, wherein the first portion of the linkage assembly and the second portion of the linkage assembly are physically connected to each other.

15. The hydraulic lift system of claim 14, wherein the first portion of the linkage assembly and the second portion of the linkage assembly are welded to each other.

16. A method of assembling a hydraulic lift system of a trailer door, including:
providing the trailer door rotatably connected to a trailer frame;
connecting a hydraulic cylinder including a piston rod extending outward at a first end of the hydraulic cylinder to a hydraulic cylinder mount connected to a frame member of the trailer frame at a second end of the hydraulic cylinder;
attaching a hydraulic pump to the trailer frame, the hydraulic pump transferring fluid to the hydraulic cylinder to move the piston rod outward at the first end of the hydraulic cylinder in an extended state, and transferring fluid from the hydraulic cylinder to move the piston rod inward at the first end of the hydraulic cylinder in a retracted state; and
connecting a linkage assembly including a first portion connected to the piston rod of the hydraulic cylinder and a second portion connected to the trailer door,
wherein an open state of the trailer door may correspond to the retracted state of the piston rod of the hydraulic cylinder, and
wherein a closed state of the trailer door may correspond to an extended state of the piston rod of the hydraulic cylinder.

17. The method of claim 16, wherein the first portion of the linkage assembly is a solid metal “L”-shaped member.

18. The method of claim 16, wherein the second portion of the linkage assembly is a solid metal plate.

19. The method of claim 17, wherein the first portion of the linkage assembly and the second portion of the linkage assembly are physically connected to each other.

20. The method of claim 19, wherein the first portion of the linkage assembly and the second portion of the linkage assembly are welded to each other.
